(19) United States
(12) Patent Application Publication
(10) Pub. No.: US 2012/0027024 A1
(43) Pub. Date: Feb. 2, 2012

(54) Zero-Setting Network Quality Service System

(76) Inventor: Ping Wen Liang, Xing Chu (TW)

(21) Appl. No.: 12/847,140

(22) Filed: Jul. 30, 2010

(51) Int. Cl. H04L 12/56

(52) U.S. Cl. 370/412

(57) ABSTRACT

A zero-setting QoS system, which is designed with priority session and bandwidth technologies in an undifferentiated network, such that the packets for universal or dedicated network can obtain priority transmission services. As a QoS system of priority levels, the network packets are received from the inlet, and 802.1q tag and 802.1p tag are loaded onto the packets, so that the packets can be transmitted by priority levels, then 802.1q tag and 802.1p tag are removed from the outlet of the system, enabling easy operation in an undifferentiated network environment; therefore, the system with rapid transmission capability can allocate and transmit the network packets within a shorter response time and by better priority levels.

### BACKGROUND OF INVENTION

1. Field of the Invention

The present invention relates to a network quality service system, and more particularly to an innovative one which is designed into an undifferentiated network of 802.1q and 802.1p based on high priority networking and bandwidth technologies.

2. Description of Related Art

With technological advancement and information liberalization under the development of Internet, a great amount of information sources, such as from multimedia, VoIP and video network, are exchanged extensively using network technologies, such as Peer-to-Peer (P2P). However, the bandwidth resources are often robbed by many IP sessions, so networking for message transmission is made impossible by the users, and both the packet transmission time and packet dropping probability increase; moreover, no transmission services of priority levels are available on previous Internet; in such case, the individuals, enterprises and governmental bodies cannot offer outstanding QoS for the users to meet their multimedia interaction demands.

To ensure network traffic flow, transmission timeliness and performance, packet transmission should be finished in shorter response time, and transmission capacity of higher priority shall be realized. Higher transmission rate is not required for common e-mails and message downloading, whilst real-time transmission quality shall be guaranteed for Internet applications such as Internet phone and video streaming. To resolve the existing network transmission problems, currently available QoS system generally employs transmission flow control mode, and enables operation and maintenance with software (hereinafter referred to as a service system with QoS software module); but under the circumstances that the bandwidth is closer to full load, real-time packeting services of high priority and intended bandwidth cannot be provided, and the network equipments must be often updated. For most of the users without sufficient Internet knowledge, many barriers will be faced with respect to actual operation and setting. Alternatively, a service system with QoS hardware module can also resolve the aforementioned network transmission problems.

The existing network transmission service technologies and systems are described below:

1. Service system without QoS module: a common network, available with FIFO for transmission and receiving of all packets, without priority levels and classification services. The maximum sessions for IP session are provided depending on the embedded memory capacity of the router. If assuming IP session is fully occupied by P2P under P2P transmission environment, congestion is likely possible and no more services are available from the network.

2. Service system with QoS software module: without IP session controller service, packets are to be analyzed and compared, and then transmitted by the priority level; moreover, QoS is guaranteed by limiting the network traffic with transmission flow control, but this method is difficult to distinguish the priority levels of packets; hence, full occupation by P2P can be prevented only by expanding maximum session with bigger memory.

The shortcomings are concluded below:

(1) Complex setting of QoS.

(2) Poorer transmission efficiency, leading to non-real-time response of packeting.

(3) Limited network flow bandwidth, and transmission capacity not fully utilized.

(4) CPU levels affecting network transmission efficiency.

3. Service system with QoS hardware module: apply network equipment in support of IEEE 802.1p or category code such as DSCP (DiffServ Code Point), by setting it at the inlet and outlet of the system; enable the network packets to be transmitted on priority; however, the additional network equipment is required to identify the packets with 802.1p or DSCP tag, otherwise priority transmission services cannot be shared; if IP sessions are extensively occupied by P2P, network quality or performance will be affected.

To sum up, the following methods are adopted to improve network transmission quality, but the shortcomings are also listed below:

(1) Additional network equipment may increase the operation and maintenance cost as well as the space.

(2) Physical memory and expenses are increased.

(3) Complex QoS setting cannot be easily finished for the service system with QoS software module.

### CONTENT OF INVENTION

The primary objective of the present invention is to provide a zero-setting QoS system, so that the packets for universal or dedicated network can obtain priority transmission services. Under an undifferentiated network environment, this system is provided with hardware module of QoS functions, allowing to receive network packets at the inlet, load and then 802.1p tag at the outlet, thus making it possible to implement an easy-to-operate QoS in common network environment.

Another objective of the present invention is to connect the network (e.g.: LAN and WAN) with two terminals in the network equipment, and provide a hardware module fitted with network chips under a VLAN environment; by setting VLAN controller, it allows to receive packets by means of port base, then set and load 802.1q tag and offer the packets with priority weight to output them accordingly; next, VLAN controller could remove 802.1q/802.1p tag information, and output by resuming into original packets as a QoS system of priority transmission functions.

Another objective of the present invention is to provide a solution for the deterioration of network quality and congestion caused from P2P. According to the definitions of Transmission Control Protocol/User Datagram Protocol (TCP/UDP), packet header and data contents, a certain quantity of network sessions are reserved on the network transmission to limit P2P session; after the packet sessions are confirmed by IP session controller, the contents of packets are labeled with 802.1p according to the levels, and loaded to hardware unit module by using Strict Priority Queue (SPQ) or Weighted Round Robin (WRR) system, and then original packets without 802.1p, 802.1q tags are output from the outlet; it is thus clear that original packets can obtain priority transmission efficiency in this system.

The present invention can provide the common packets with a priority transmission service under an undifferentiated network environment, without need of complex setting and additional network equipments; this makes it possible to realize rapid transmission capability, shorter response time and better priority allocation & transmission capability for the packets in common network or special circumstances; in such case, this system can receive the packets from differentiated network and output to the differentiated network by resuming into original packets.

### SUMMARY OF THE INVENTION

FIG. 1 depicts the transmission concept view of a preferred embodiment of the telecommunication system. The purpose of the present invention is to connect the network with two or more terminals via QoS system 1 of the present invention under an undifferentiated network environment, of which one terminal is connected to LAN 2 with one or two interfaces, comprising: wired or wireless network; the other terminal is connected to WAN 3 with one or two interfaces, comprising: wired network, wireless network, 3G/3.5G/4G telecom network, fibre-optic telecom network or xDSL data communication network. For the common network, i.e.: undifferentiated network, the packets are not available with priority transmission functions.

QoS system 1 of the present invention mainly comprises: input processor 11, packet processor 12 and output processor 13. Firstly, the system is designed into a VLAN and different VLAN groups are established; the input processor 11 is used to receive packets, and load 802.1q tag onto all packets, the packet processor 12 is used to load 802.1p tag onto the packets, and transfer them by priority levels; prior to transmission, the output processor 13 shall remove 802.1q/802.1p information, and resume into original packets without 802.1q/802.1p information, so that packet can be transferred on this system by priority levels.

FIG. 2 depicts the system concept view of a preferred embodiment of the present invention, wherein the zero-setting QoS system 1 comprises: an inlet 100, a VLAN controller 110, an IP session controller 120, a packet checker 130, a packet marker 140, a queue manager 150, a priority queue 160, a transmission mechanism 170, a priority queue hardware unit 180 and an outlet 190; the main functions of the units are described below:

Inlet 100: receive the source packets from undifferentiated network.

VLAN controller 110: allocate the source packets received from inlet 100 via the port, load 802.1q tag onto the packet header, and remove 802.1q tag during transmission of the packets.

IP session controller 120: manage the sessions of TCP/IP (Transmission Control Protocol/Internet Protocol).

Packet checker 130: check if the packets are labeled with 802.1p.

Packet marker 140: classify the grades by the packet information, and load 802.1p tag weight onto all packets.

Queue manager 150: send 802.1p tag loaded onto the packets to the priority queue by different priority weights.

Priority queue 160: queue the packets according to the priority weights of 802.1p tag.

Transmission mechanism 170: output the packets in the priority queue 160.

Priority queue hardware unit 180: a hardware unit module, embedded with several queues in line with priority weights of 802.1p tag, used to receive and send the packets.

Outlet 190: send the packets to undifferentiated network.

The system of the present invention is based on VLAN groups established in a VLAN (Virtual Local Area Network); by setting a VLAN controller 110, a port is allocated to receive source packets of undifferentiated network from inlet 100; and VLAN controller 110 is used to load 802.1q tag into the packet header to become VLAN header; after packet session is established from packet information by IP session controller 120, the packet checker 130 will check if the packets are available with 802.1p tag information, otherwise, the packet marker 140 will define high priority, secondary high priority, medium priority and low priority according to the priority weights, then set 802.1p tag weight, and then the queue manager 150 will decide to send the packets to the priority queue 160 by the priority weight; the priority queue 160 is composed of several queues, comprising: a high priority queue 161, a secondary high priority queue 162, a medium priority queue 163 and a low priority queue 164, which are allocated with different priority weights according to 802.1p tag; and the packets are separately arranged into high priority queue 161, secondary high priority queue 162, medium priority queue 163 and low priority queue 164, and then sent out subsequently; of which, memory hardware unit may be applied to several queues, and planned to realize different memory addresses and blocks for queuing, access and transmission purposes; next, the transmission mechanism 170 permits to output the packets composed of several priority queues 160; the transmission mechanism 170 further comprises: a SPQ mechanism 171 and a WRR mechanism 172, of which SPQ mechanism 171 permits to send the packets by high priority queue 161, followed by secondary high priority queue 162, medium priority queue 163 and low priority queue 164; in addition, WRR mechanism 172 permits to send the aforementioned queues by proportional allocation mode to guarantee the transmission of low priority queue; this system may select a mode to send the packets to the priority queue hardware unit 180; the priority queue hardware unit 180 is used to receive and send packet transmission queues, comprising: a high priority queue 181, a secondary high priority queue 182, a medium priority queue 183 and a low priority queue 184; similarly, the packets sent by the transmission mechanism 170 of priority queue 160 are output from the several queue of the priority queue hardware unit 180 according to the priority weights, and the packets with 802.1p and 802.1q tags are also output; before output of the packets from the outlet 190, VLAN controller 110 shall remove 802.1q tag in the packets, of which 802.1p tag is loaded into 802.1q tag; hence, original packets without 802.1p, 802.1q tags can be output and then sent from the outlet 190 to undifferentiated network.

FIG. 3 depicts a flow process of a preferred embodiment of the present invention, wherein an available QoS network chip, e.g.: RALINK RT3052 QoS network chip, in support of 802.1p/802.1q, is set in the hardware module with network chips, for instance, said VLAN controller 110, and priority queue hardware unit 180 of 802.1p priority weight; this system establishes VLAND groups in a VLAN environment, so as to receive and transmit the packets of Ethernet. The flow process of the present invention is described and judged below:

Step 400: receive the source packets from undifferentiated network via inlet 100;

Step 410: VLAN controller 110 loads 802.1q tag onto packet header for the received source packet;

Step 420: judge if packet session is established.

Step 430: the packet checker 130 checks if packet is available with 802.1p tag.
If not, perform Step 431 to classify the contents of packets.
If yes, consider as packet data, and add the contents of original 802.1p tag into VLAN header established by this system, then perform Step 450.

Step 440: the packet marker 140 defines the weight of packets and sets 802.1p tag weight onto VLAN header.

Step 450: the queue manager 150 sends the packets of different priority weights to priority queue 160 according to the loaded 802.1p tag.

Step 460: select transmission mechanism 170, either SPQ 171 or WRR 172, to transmit the packets of priority queue 160 to the priority queue hardware unit 180.

Step 470: priority queue hardware unit 180 receives and transmits packets from several queues of priority weight.

Step 480: VLAN controller 110 removes 802.1q and 802.1p tags.

Step 490: send out packets from outlet 190.

In the aforementioned flow process, IP session controller 120 is used to judge if packet session is established (Step 420); IP session controller 120 is involved with IP session; packet session is established by setting the number of non-reserved sections and the number of reserved sections, and the session is established by the following judgments according to the number of non-reserved sections and the number of reserved sections occupied by session.

Step 421: check if packet session has reached the number of non-reserved sections and the number of reserved sections, then abandon packet (Step 421a) without establishment of the session.

Step 422: check if packet session has reached the number space for the number of non-reserved sections, but there is still number space for the number of reserved sections; then check if the packet is within the scope of VLAN packet defined by the system (Step 422a); if yes, perform Step 430, if not, abandon the packet (Step 422b), without establishment of the session. In the VLAN packet scope defined by the system, the definitions are made according to TCP/UDP port or protocol, packet header and data contents.

Step 423: if the number of non-reserved sections and the number of reserved sections still have the number space, the session is established, or if the session is already established, perform Step 430.

According to the network session, a certain number of reserved sections is set to limit P2P session; the number of reserved sections refers to the packets used on universal or dedicated network to ensure establishment of session; in addition, the number of non-reserved sections is the maximum session minus the number of reserved sections, and also means that there is still space number for session establishment irrespective of the packet contents.

Of which, it is required to perform Step 431 to classify the contents of the packets, define them by the priority levels and set 802.1p tag weights (Step 440), then distinguish the packets of different priority levels by setting 802.1p tag weight according to the characteristics of packet contents; for common e-mails and information downloading, it is required to set 802.1p tag weight of lower priority level at lower transmission rate; for real-time transmission network such as: Internet phone and video streaming requiring for bandwidth guarantee, it is required to set 802.1p tag weight of higher priority level.

Referring to FIG. 4, if performing Step 430, the original packet is available with 802.1p tag; with the use of double VLAN tag, 802.1p tag in original packet is considered as packet data, and new 802.1p tag is loaded to prevent removal during transmission of packets. As shown in FIG. 4, the first column is the Ethernet frame with 802.1p tag, comprising from left to right: destination address (DA), source address (SA), Ether Type, tag 1, packet length/Ether Type, data and Frame Check Sequence (FCS); the second column is the frame with double VLAN tag, comprising from left to right: destination address, source address, Ether Type, tag 2, Ether Type, tag 1, packet length/Ether Type, data and FCS. According to 802.1p tag 1 for original packet, tag 2 for 802.1p priority weight is reset, and original packet is allowed to enjoy priority weight transmission functions; in these steps, go to Step 450 directly without Step 440, and send the original packet with 802.1p tag information to the differentiated network.

In a VLAN environment, the present invention permits all transmitted packets to be loaded with 802.1q and 802.1p tag, and then distributed to priority queue 160 by the priority weights; next, the priority weights are distinguished by the priority queue hardware unit 180, so high and low priority packets can be transmitted by more distinctive priority levels, thereby improving said QoS software module service system; yet, limiting the network flow bandwidth with transmission flow control is difficult to distinguish the priority levels, and the transmission capacity cannot be fully utilized; the hardware module with network chips doesn't require complex setting of QoS, without limitation by CPU levels, etc, so the transmission mode enables faster transmission than that with QoS software module.

Additional network equipment is provided to ensure packet transmission by priority levels in universal or dedicated packet network applications, but 802.1p tag must be identified at the inlet and outlet of the network equipment for priority transmission. On a comparative basis, the system of the present invention without additional network equipment allows to connect the network (LAN 2 and WAN 3) with two terminals, and provide VLAN groups in a VLAN environment; by setting VLAN controller 110, it allows to receive packets by means of port base, then set and load 802.1q tag and transmit the packets by priority levels; as this system is provided with hardware module fitted with network chips, VLAN controller 110 could remove 802.1q/802.1p information during output of packets, and resume into original packets without 802.1q/802.1p information, thus realizing a zero-setting QoS system 1 of priority transmission functions; in particular, when the packets of higher priority are allocated and transmitted, it is possible to limit the situation of extensive occupation by P2P and guarantee rapid transmission capability and response time.

The “zero-setting QoS system” of the present invention is designed with zero-setting priority session and bandwidth technologies, and characterized by good performance and cost-effectiveness, so the patent claims are put forward hereunder.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1: a transmission concept view showing a preferred embodiment of the telecommunication system of the present invention.

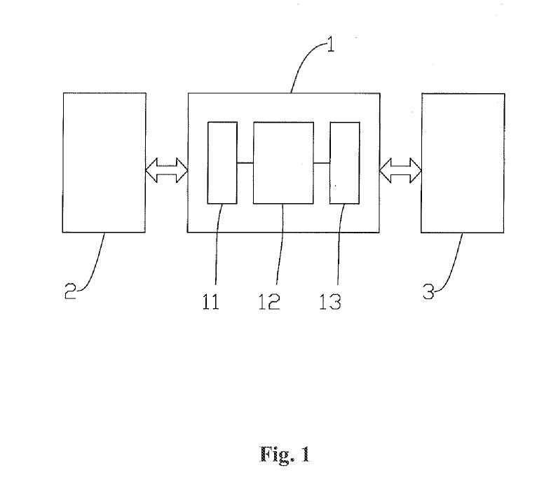

FIG. 2: a system concept view of a preferred embodiment of the present invention.

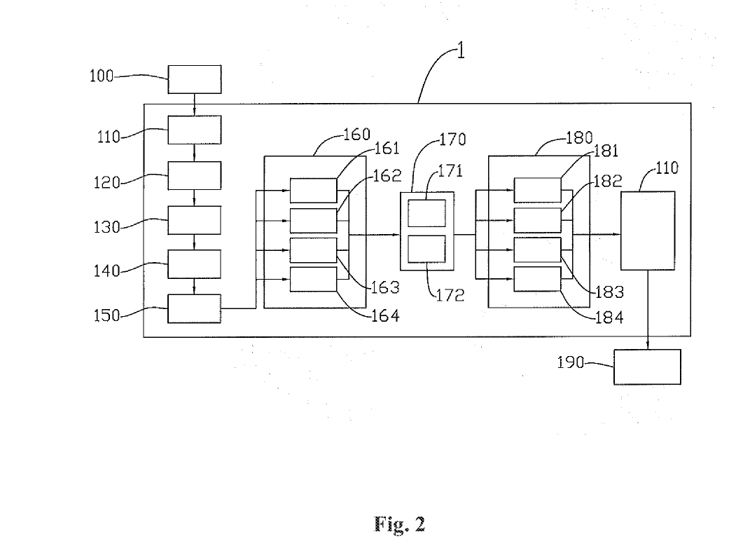

FIG. 3: a flow process of a preferred embodiment of the present invention.

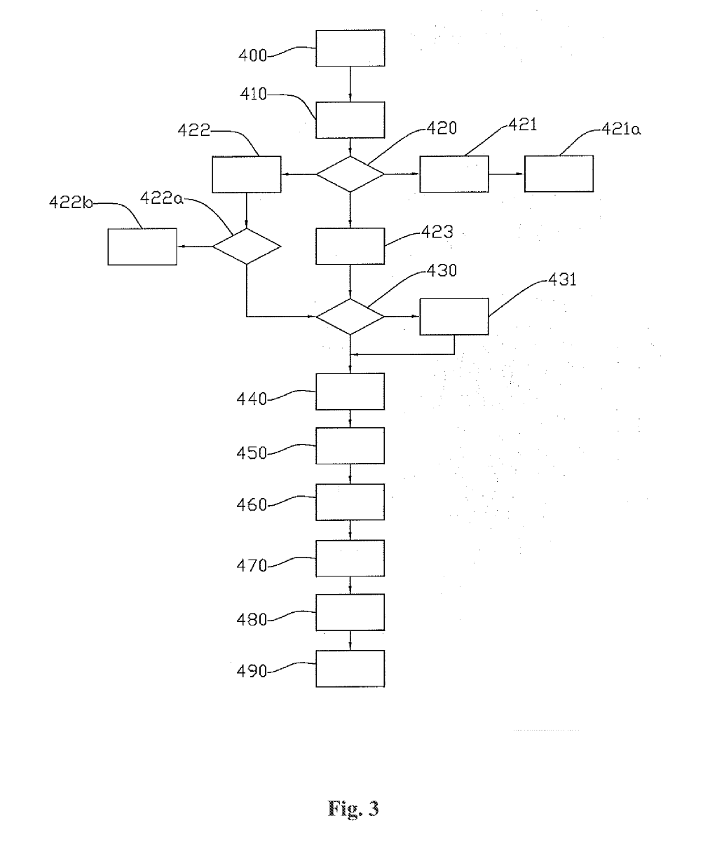

FIG. 4: a view of the present invention with double VLAN tags.

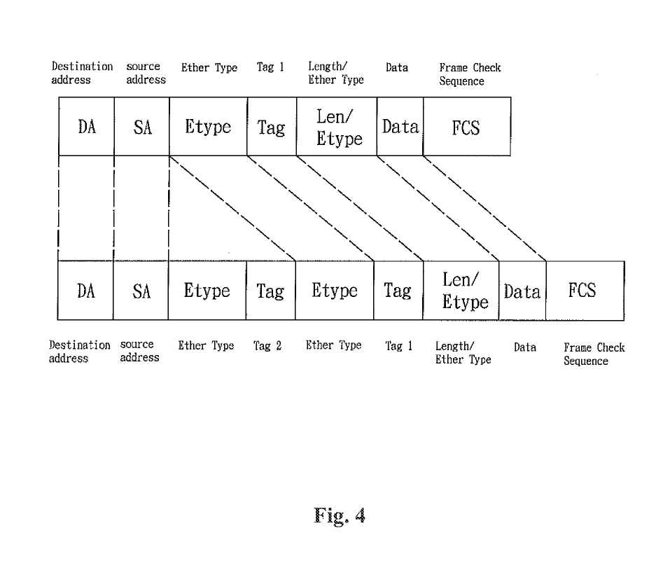

1. A zero-setting QoS system, comprising:
a VLAN controller, used to receive source packets, load 802.1q tag onto packet header, and remove 802.1q tag of the packet before output of the packet;
a packet marker, used to load 802.1p tag weight onto all packets;
a queue manager, used to send 802.1p tag loaded onto the packets to the priority queue by different priority weights;
a priority queue, used to queue the packets according to the priority weights of 802.1p tag, and a transmission mechanism used to output the packets in several queues;
a priority queue hardware unit, a hardware unit module, embedded with several queues in line with priority weights of 802.1p tag, and used to send the packets from the priority queues via the transmission mechanism.

2. The zero-setting QoS system as claimed in claim 1, wherein VLAN controller receives the source packets from undifferentiated network via an inlet.

3. The zero-setting QoS system as claimed in claim 1, wherein the priority queue hardware unit outputs the source packets from the outlet to the undifferentiated network.

4. The zero-setting QoS system as claimed in claim 3, wherein VLAN controller removes 802.1q tag of the packet and the loaded 802.1p tag before the priority queue hardware unit outputs the packet at the outlet.

5. The zero-setting QoS system as claimed in claim 1, wherein the priority queues based on 802.1p priority weight further comprise: high priority queue, secondary high priority queue, medium priority queue and low priority queue.

6. The zero-setting QoS system as claimed in claim 1, wherein the transmission mechanism for priority queue further comprises: SPQ and WRR mechanism, either of which is selected to send the packets of priority queue to the priority queue hardware unit.

7. The zero-setting QoS system as claimed in claim 1, wherein the queues of the priority queue hardware unit based on 802.1p priority weight further comprise: high priority queue, secondary high priority queue, medium priority queue and low priority queue.

8. A zero-setting QoS system with the following processes:
(1) receive the source packets from undifferentiated network via inlet;
(2) VLAN controller 110 loads 802.1q tag onto packet header for the received source packet;
(3) judge if packet session is established;
(4) the packet checker checks if packet is available with 802.1p tag;
(5) the packet marker loads 802.1p tag priority weight;
(6) the queue manager sends the packets of different priority weights to priority queue according to the loaded 802.1p tag;
(7) select transmission mechanism 170, either SPQ 171 or WRR 172, to transmit the packets of priority queue to the priority queue hardware unit;
(8) priority queue hardware unit receives and transmits packets from several queues of priority weight;
(9) VLAN controller removes 802.1q and 802.1p tags for the packets transmitted by the priority queue hardware unit;
(10) send out packets from outlet.

9. The zero-setting QoS system method as claimed defined in claim 8, wherein Step 3: establishment of packet session is implemented by an IP session controller, which is involved with IP session.

10. The method defined in claim 9, wherein IP session controller allows to establish packet session by setting the number of non-reserved sections and the number of reserved sections; the session can be established if there is still number space for the number of non-reserved sections and the number of reserved sections.

11. The zero-setting QoS system method as claimed in claim 9, wherein IP session controller allows to establish packet session by setting the number of non-reserved sections and the number of reserved sections; the session isn't established if the packet session has reached both the number of non-reserved sections and the number of reserved sections.

12. The zero-setting QoS system method as claimed in claim 9, wherein IP session controller allows to establish packet session by setting the number of non-reserved sections and the number of reserved sections; the session can be established if the number of non-reserved sections has reached the number space but there is still number space for the number of reserved sections.

13. The zero-setting QoS system method as claimed in claim 8, wherein Step 4: the packet checker checks if packet is available with 802.1p tag, if yes, 802.1p tag in the packet is considered as data; so, with the use of double VLAN tag method, 802.1p tag in original packet is considered as packet data, then new 802.1p tag is loaded onto original packets and sent directly to Step 6: priority queue, and finally the original packets are sent to the differentiated network from the outlet.
